(19) United States
(12) Patent Application Publication
(10) Pub. No.: US 2020/0061675 A1
(43) Pub. Date: Feb. 27, 2020

(54) Bacteria-controlling and stain-removing system for handrails in public places

(71) Applicant: Dingfang Shuai, Foshan (CN)

(72) Inventor: Dingfang Shuai, Foshan (CN)

(21) Appl. No.: 16/666,408

(22) Filed: Oct. 29, 2019

(30) Foreign Application Priority Data
Jul. 9, 2019 (CN) 201910616284X

(51) Int. Cl. B08B 1/00; B66B 31/02

(52) U.S. Cl. CPC B08B 1/008; B66B 31/02

(57) ABSTRACT

This invention discloses a bacteria-controlling and stain-removing system for handrails in public places, including clamping blocks of bilateral symmetry, a moving mechanism arranged in the clamping blocks, and the movable mechanism includes two symmetrical top wheels; the top wheel can move up and down along with the size of the handrail; a transverse rotating wheel is arranged in the clamping block, and the handrail can be clamped through the transverse rotating wheel, so that the device can move along the handrail, and a driving mechanism is arranged on the moving mechanism, so that the overall linkage is high, and one-time repeated movement can be automatically completed on the handrail, spraying the sterilizing liquid uniformly on the handrail, wiping residual bacteria removing liquid, and maintaining the cleanness of the handrail, the size and the width of the handrail can be adjusted, the internal size can be automatically adjusted by the device.

### CROSS-REFERENCES TO RELATED APPLICATIONS

The present application claims priority from Chinese application No. 201910616284X filed on Jul. 9, 2019 which is hereby incorporated by reference in its entirety.

### TECHNICAL FIELD

The present invention relates to the technical field of handrail sterilization, in particular to a bacteria-controlling and stain-removing system for handrails in public places.

### BACKGROUND OF THE INVENTION

The handrail is used in public places, and many people touched it, thereby it is easy to contaminate a large amount of bacteria, and the handrail needs to be cleaned and sterilized frequently, however, the existing method for carrying out sterilization and stain removal on the handrail is mainly labor-saving, consumes more manpower and time, and is relatively tedious in cleaning work according to handrails with different sizes.

### BRIEF SUMMARY OF THE INVENTION

The invention aims to provide a bacteria-controlling and stain-removing system for handrails in public places, and aims to solve the problems of manpower and time for handrail sterilization, handrail cleaning of different sizes and the like.

The invention is realized by the following technical proposal:

A bacteria-controlling and stain-removing system for handrails in public places of present invention comprises two clamping blocks which are bilaterally symmetric, and a moving mechanism is arranged in the clamping blocks, the movable mechanism comprises two left and right symmetrical top wheels, and the handrails can be clamped up and down through the top wheels and the clamping blocks, the top wheel can move up and down along with the size of the handrail, and a rotatable transverse rotating wheel is arranged in the clamping block, the left and right sides of the handrail can be clamped by the transverse rotating wheel, so that the device can move along the handrail;

a driving mechanism is arranged on the upper side of the moving mechanism and comprises a top plate, and a motor is installed on the lower end face of the top plate, the transverse rotating wheel can be driven to rotate through the working of the motor, and the moving mechanism is in friction transmission with the driving mechanism through a belt;

a sterilization mechanism is arranged in the top plate, and comprises a storage block embedded in the top plate, and a storage cavity is formed in the storage block, the sterilization liquid is arranged in the storage cavity, and when the device moves along the handrail, the sterilization liquid in the storage cavity can be uniformly sprayed on the upper end surface of the handrail through the spray head;

an erasing mechanism is arranged on the rear side of the degerming mechanism and comprises a square cavity with a downward opening, a rotatable sponge block is arranged in the square cavity, and a movable cavity with an upward opening is formed in the right end wall of the square cavity, a rack is arranged in the moving cavity in a sliding mode, and the sponge block can be driven to rotate to the upper end surface of the handrail when the rack moves, so that the residual bacteria removing liquid on the upper end surface of the handrail can be wiped off.

Preferably, the moving mechanism comprises a containing cavity located in the clamping block, and the opening of the containing cavity faces the handrail, and a rotating shaft which penetrates through the upper end wall of the containing cavity and is positioned in the outside space is arranged on the lower end wall of the containing cavity in a rotating mode, the rotating shaft in the containing cavity is fixedly provided with the transverse rotating wheel, and the rotating shaft is fixedly provided with a belt wheel, away from the handrail, of the clamping block, and an elastic spring is fixedly arranged on the end wall, close to the handrail, of the elastic cavity, far away from the handrail, of the elastic spring is fixedly provided with a supporting rod in sliding connection with the elastic cavity, and the supporting rod is fixedly connected with the top plate, stress blocks are symmetrically and symmetrically fixed on the right side of the lower end surface of the clamping block, and an elastic cavity with a downward opening is arranged in the stress block, an elastic spring is fixedly arranged on the upper end wall of the elastic cavity, and an elastic rod which is in sliding connection with the elastic cavity is fixedly arranged at the lower end of the elastic spring, elastic shafts are arranged between the two elastic rods in a rotating mode, and the top wheels are fixedly arranged on the elastic shafts.

Preferably, the driving mechanism further comprises a transmission shaft rotationally connected with the lower end surface of the top plate, a transmission gear and a transmission rod are fixedly arranged on the transmission shaft, and the transmission rod is positioned on the lower side of the transmission gear, a motor shaft is rotationally arranged on the lower end surface of the motor, and a driving gear which is in meshed transmission with the transmission gear is fixedly arranged at the lower end of the motor shaft, the transmission shaft is connected with two first conical blocks and two second conical blocks in a sliding mode, an extending cavity with a downward opening is formed in the first conical block, and an extending spring is fixedly arranged on the upper end wall of the extending cavity, and an extending block which is in sliding connection with the extending cavity is fixedly arranged at the lower end of the extending spring, and an extension rod fixedly connected with the upper end surface of the second conical block is fixedly arranged on the lower end surface of the extension block, the belt is arranged between the second conical block and the first conical block, and the belt is in friction transmission with the belt wheel.

Preferably, a guide block is fixedly arranged on the rack in the movable cavity, and the guide block is in sliding connection with the movable cavity, a sensor is embedded in the right end wall of the moving cavity, and the sensor is connected with the motor through a data line.

Preferably, the sterilization mechanism further comprises a one-way cavity located in the top plate, and the upper end wall of the one-way cavity is communicated with the storage cavity through a guide pipe, a first one-way valve is arranged in the guide pipe, and a spraying guide pipe is arranged on the lower end wall of the first one-way valve, the lower end of the spraying guide pipe is positioned on the upper side of the handrail and is fixedly provided with the spray head, and a second one-way valve is arranged in the spraying guide pipe, a rotating cavity with a downward opening is formed in the right end wall of the one-way cavity, and a piston is arranged in the one-way cavity in a sliding mode, a piston rod which is positioned in the rotating cavity is fixedly arranged on the right end surface of the piston, and a threaded shaft which is rotationally connected with the right end wall of the rotating cavity is in threaded connection with the inner thread of the piston rod, and a first torsion spring is arranged between the threaded shaft and the right end wall of the rotating cavity, a vertical rod positioned in the external space is fixedly arranged on the lower end surface of the threaded shaft, and a short shaft is rotationally arranged in the left end surface of the vertical rod, a second torsion spring is arranged between the short shaft and the vertical rod, and a stressed rod is fixedly arranged at the left end of the short shaft.

Preferably, the erasing mechanism further comprises an output shaft rotationally connected with the upper end wall of the square cavity, an output gear is fixedly arranged on the output shaft, the output gear is in meshed transmission with the rack, and a large bevel gear is fixedly arranged at the lower end of the output shaft, a power shaft is rotationally arranged on the right end wall of the square cavity, a small bevel gear and a rotating rod are fixedly arranged on the power shaft, and the rotating rod is located on the left side, the small bevel gear is in meshed transmission with the large bevel gear, and the sponge block is fixedly arranged at the rear end of the rotating rod.

The device disclosed by the invention has the beneficial effects that only one motor is used, and the overall linkage is relatively high, one-time repeated movement can be automatically completed on the handrail, the handrail can be uniformly sprayed with the bacteria removing liquid, and residual bacteria removing liquid can be wiped off, the cleaning of the handrail is maintained, the internal size can be automatically adjusted according to the size and the width of the handrail, the adaptability is high, the automation degree of the device is high, and manpower is saved.

### BRIEF DESCRIPTION OF THE DRAWINGS

For better explaining the technical proposal in the present invention embodiments or the prior art, the drawings to be used in the description of the embodiments or the prior art will be briefly described below.

FIG. 1 is a schematic diagram of a main view structure of an integral full subdivision of a bacteria-controlling and stain-removing system for handrails in public places;

FIG. 2 is an enlarged schematic view of A in FIG. 1;

FIG. 3 is an enlarged schematic view of B in FIG. 1;

FIG. 4 is a schematic view of C-C in FIG. 1;

FIG. 5 is a schematic view of D-D in FIG. 1;

FIG. 6 is a schematic view of E-E in FIG. 1.

### DETAILED DESCRIPTION OF THE INVENTION

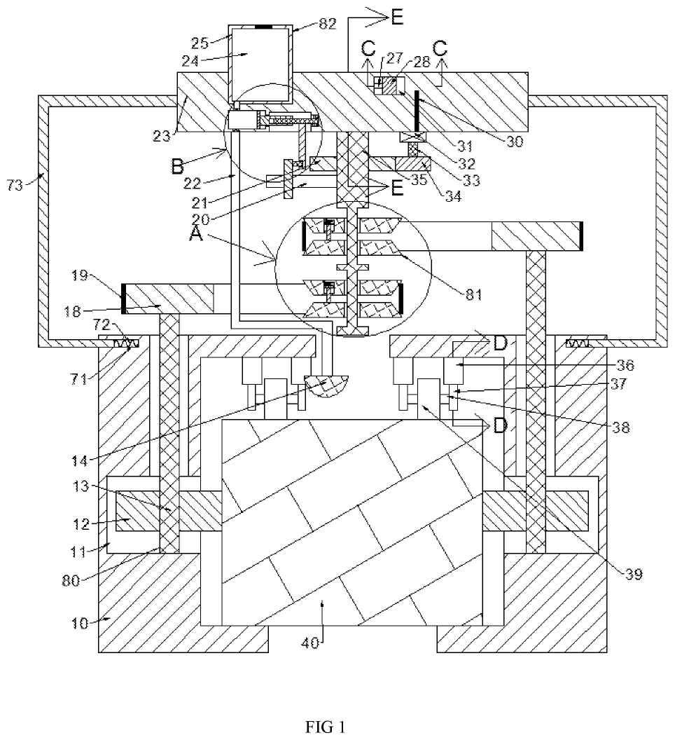

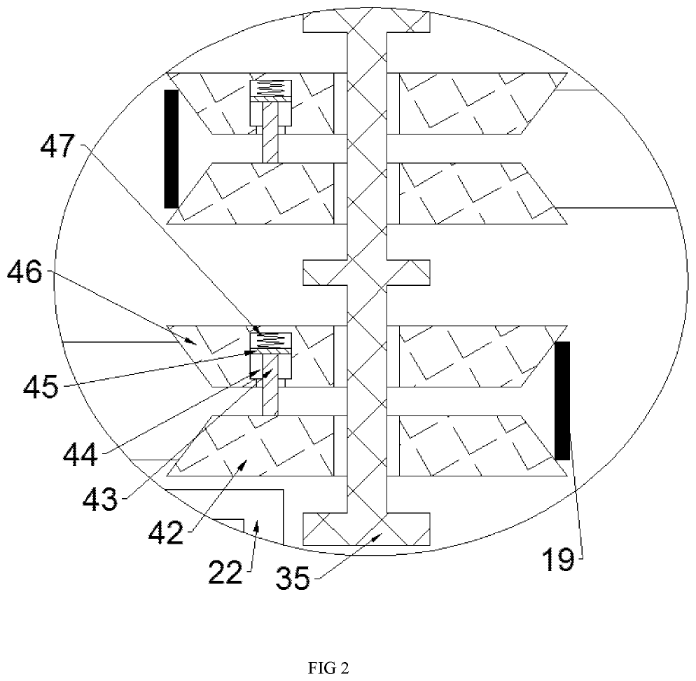

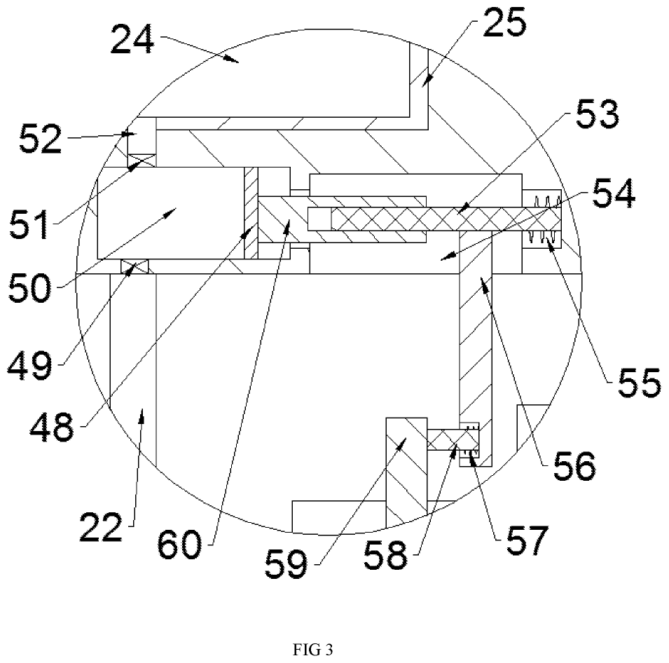

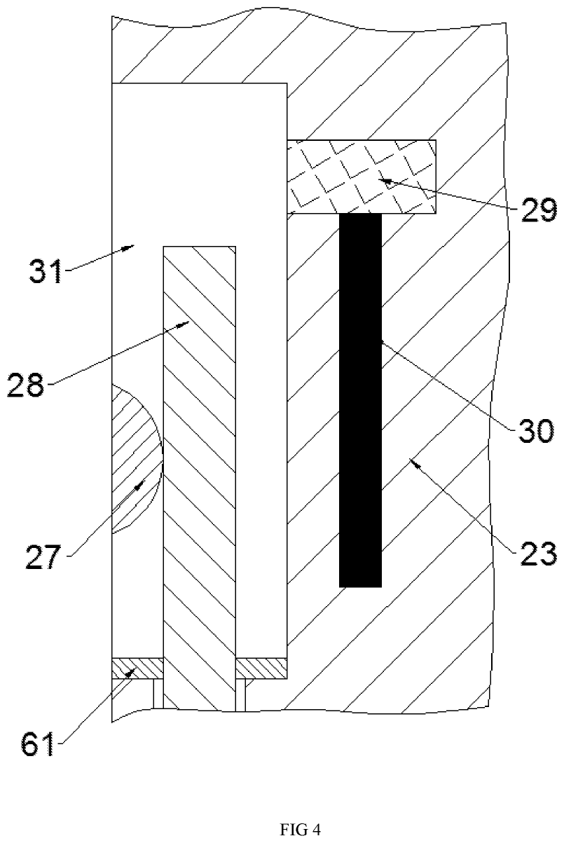

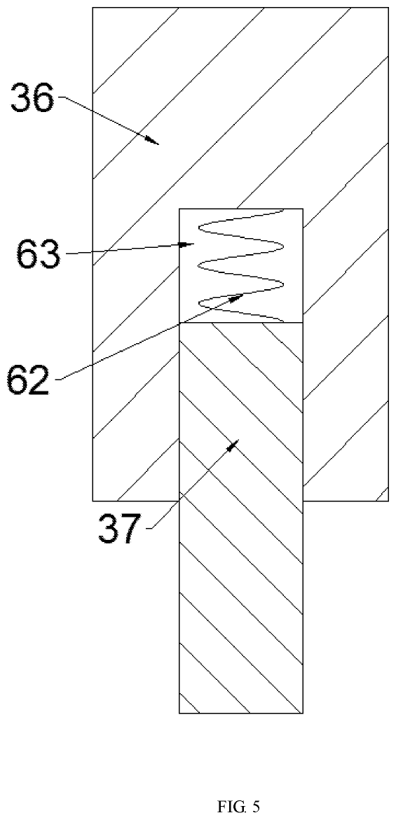

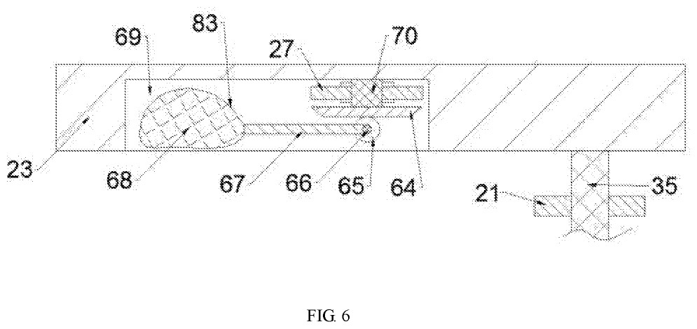

The invention will be described in detail below referring to FIG. 1 to FIG. 6. For better explanation, the orientations described hereinafter are defined as follows: directions of up, down, left, right, front and rear in the text are identical to the directions of up, down, left, right, front and rear of FIG. 1.

A bacteria-controlling and stain-removing system for handrails in public places according to the present invention, includes two left and right symmetrical clamping blocks 10, and a moving mechanism 80 is arranged in each clamping block 10, the movable mechanism 80 comprises two left and right symmetrical top wheels 39, and the handrails 40 can be clamped up and down through the top wheels 39 and the clamping blocks 10, the top wheel 39 can move up and down along with the size of the handrail 40, and a rotatable transverse rotating wheel 12 is arranged in the clamping block 10, the transverse rotating wheel 12 can clamp the handrail 40 left and right, so that the device can move along the handrail 40;

a driving mechanism 81 is arranged on the upper side of the moving mechanism 80, and comprises a top plate 23, and a motor 32 is installed on the lower end face of the top plate 23, the transverse rotating wheel 12 can be driven to rotate through the working of the motor 32, and the moving mechanism 80 is in friction transmission with the driving mechanism 81 through a belt 19;

a degerming mechanism 82 is arranged in the top plate 23, the sterilization mechanism 82 comprises a storage block 25 embedded in the top plate 23, and a storage cavity 24 is formed in the storage block 25, and a sterilization liquid is arranged in the storage cavity 24 when the device moves along the handrail 40, and the sterilization liquid in the storage cavity 24 can be uniformly sprayed on the upper end surface of the handrail 40 through the spray head 14;

an erasing mechanism 83 is arranged on the rear side of the degerming mechanism 82, and comprises a square cavity 69 with a downward opening, a rotatable sponge block 68 is arranged in the square cavity 69, and a movable cavity 31 with an upward opening is formed in the right end wall of the square cavity 69, a rack 28 is arranged in the moving cavity 31 in a sliding mode, and the sponge block 68 can be driven to rotate to the upper end surface of the handrail 40 when the rack 28 moves, so that the residual bacteria removing liquid on the upper end surface of the handrail 40 can be wiped off.

Further, the moving mechanism 80 is described in detail, and the moving mechanism 80 comprises a containing cavity 11 positioned in the clamping block 10, an opening of the containing cavity 11 faces the handrail 40, and a rotating shaft 13 with the upper end penetrating through the upper end wall of the containing cavity 11 and located in the outside space is rotationally arranged on the lower end wall of the containing cavity 11, a transverse rotating wheel 12 is fixedly arranged on the rotating shaft 13 in the containing cavity 11, and a belt wheel 18 is fixedly arranged on the rotating shaft 13, far away from the handrail 40, of the clamping block 10, and an elastic cavity 71 which is far away from the handrail 40 is formed in the end surface of the clamping block 10 far away from the handrail 40, close to the end wall of the handrail 40, of the elastic cavity 71, and an elastic spring 72 is fixedly arranged at the end, close to the handrail 40, of the elastic cavity 71, a supporting rod 73 slidably connected with the elastic cavity 71 is fixedly arranged at one end, far away from the handrail 40, of the elastic spring 72, and the supporting rod 73 is fixedly connected with the top plate 23, a stress block 36 is symmetrically and fixedly arranged on the right side of the lower end surface of the clamping block 10, and an elastic cavity 63 with a downward opening is formed in the stress block 36, an elastic spring 62 is fixedly arranged on the upper end wall of the elastic cavity 63, and an elastic rod 37 which is in sliding connection with the elastic cavity 63 is fixedly arranged at the lower end of the elastic spring 62, an elastic shaft 38 is rotationally arranged between the two elastic rods 37, and the top wheel 39 is fixedly arranged on the elastic shaft 38.

Further, the driving mechanism 81 is described in detail, and the driving mechanism 81 further comprises a transmission shaft 35 connected with the lower end surface of the top plate 23 in a rotating mode, a transmission gear 21 and a transmission rod 20 are fixedly arranged on the transmission shaft 35, and the transmission rod 20 is located on the lower side of the transmission gear 21, a motor shaft 33 is rotationally arranged on the lower end face of the motor 32, and a driving gear 34 which is in meshed transmission with the transmission gear 21 is fixedly arranged at the lower end of the motor shaft 33, the transmission shaft 35 is slidably connected with two first conical blocks 46 and two second conical blocks 42, an extending cavity 44 with a downward opening is formed in the first conical block 46, and an extension spring 47 is fixedly arranged on the upper end wall of the extending cavity 44, and an extension block 45 which is in sliding connection with the extension cavity 44 is fixedly arranged at the lower end of the extension spring 47, and an extension rod 43 fixedly connected with the upper end surface of the second conical block 42 is fixedly arranged on the lower end surface of the extension block 45, a belt 19 is arranged between the second conical block 42 and the first conical block 46, and the belt 19 is in friction transmission with the belt wheel 18;

a guide block 61 is fixedly arranged on the rack 28 in the movable cavity 31, and the guide block 61 is in sliding connection with the movable cavity 31, a sensor 29 is embedded in the right end wall of the moving cavity 31, and the sensor 29 is connected with the motor 32 through a data line 30.

Further, the sterilization mechanism 82 is described in detail, the sterilization mechanism 82 further comprises a one-way cavity 50 located in the top plate 23, the upper end wall of the one-way cavity 50 is communicated with the storage cavity 24 through a guide pipe 52, a first one-way valve 51 is arranged in the guide pipe 52, and a spraying guide pipe 22 is arranged on the lower end wall of the first one-way valve 51, the lower end of the ejection conduit 22 is positioned on the upper side of the armrest 40 and is fixedly provided with the nozzle 14, and a second one-way valve 49 is arranged in the ejection conduit 22, a rotating cavity 54 with a downward opening is arranged in the right end wall of the one-way cavity 50, and a piston 48 is arranged in the one-way cavity 50 in a sliding mode, and a piston rod 60 positioned in the rotating cavity 54 is fixedly arranged on the right end surface of the piston 48, the piston rod 60 is in threaded connection with a threaded shaft 53, and the right end of the threaded shaft 53 is rotationally connected with the right end wall of the rotating cavity 54, a first torsion spring 55 is arranged between the threaded shaft 53 and the right end wall of the rotating cavity 54, the lower end surface of the threaded shaft 53 is fixedly provided with a vertical rod 56 positioned in the external space, and a short shaft 58 is rotationally arranged in the left end surface of the vertical rod 56, a second torsion spring 57 is arranged between the short shaft 58 and the vertical rod 56, and a stressed rod 59 is fixedly arranged at the left end of the short shaft 58.

Further, the erasing mechanism 83 is described in detail, and the erasing mechanism 83 further comprises an output shaft 70 rotationally connected with the upper end wall of the square cavity 69, an output gear 27 is fixedly arranged on the output shaft 70, the output gear 27 is in meshed transmission with the rack 28, and a large bevel gear 64 is fixedly arranged at the lower end of the output shaft 70, a power shaft 66 is rotationally arranged on the right end wall of the square cavity 69, a small bevel gear 65 and a rotating rod 67 are fixedly arranged on the power shaft 66, and the rotating rod 67 is located on the left side, the small bevel gear 65 is in meshed transmission with the large bevel gear 64, and the sponge block 68 is fixedly arranged at the rear end of the rotating rod 67.

Advantageously, the sensor 29 is used for detecting the rack 28 and controlling the working state of the motor 32 according to the state of the rack 28.

Sequence of mechanical actions of the entire apparatus:

firstly, the motor 32 is started, at the moment, the sensor 29 detects that the rack 28 is not located, the motor 32 drives the motor shaft 33 to rotate in the forward direction, and the driving gear 34 rotates along with the motor shaft 33.

secondly, the transmission gear 21 is driven to rotate through the meshing transmission of the driving gear 34 and the transmission gear 21, and the transmission rod 20, the second conical block 42 and the first conical block 46 rotate along with the transmission gear 21.

thirdly, through friction transmission of the belt 19, the second conical block 42 and the first conical block 46 drive the belt wheel 18 to rotate, and the transverse rotating wheel 12 rotates along with the belt wheel 18, the driving device moves backwards on the armrest 40, the transmission rod 20 rotates to push the short shaft 58 to rotate, and the vertical rod 56 rotates along with the short shaft 58 to drive the threaded shaft 53 to rotate, and is driven by the meshing transmission of the threaded shaft 53 and the piston rod 60 to drive the piston 48 to spray the disinfectant in the one-way cavity 50 out of the spray head 14 through the spray conduit 22, the surface of the handrail 40 is disinfected, and after the transmission rod 20 is separated from the stress rod 59, the first torsion spring 55 is reset, the piston 48 is driven to reset, and the disinfectant in the storage cavity 24 is sucked into the one-way cavity 50.

fourthly, after moving to the end of the handrail 40, the end part of the handrail 40 pushes the rack 28 to move towards the moving cavity 31, and the gear rack 28 is meshed with the output gear 27, drives the output gear 27 to rotate, the large bevel gear 64 rotates along with the output gear 27, and the large bevel gear 64 is meshed and transmitted with the small bevel gear 65, the sponge block 68 is driven to rotate ninety degrees, so that the square cavity 69 is in contact with the upper end surface of the handrail 40, and the sensor 29 detects the rack 28, so that the motor 32 changes the working state, the motor shaft 33 is driven to rotate reversely, so that the device moves and resets along the handrail 40, and the square cavity 69 is used for wiping the residual disinfectant on the upper end surface of the handrail 40.

The above-mentioned embodiments are merely illustrative of the technical conception and characteristics of the present invention, the purpose of the present invention is to enable those skilled in the art to understand the contents of the present invention and implement the same, and cannot limit the protection scope of the present invention. All equivalent changes or modifications made according to the spirit of the present invention shall fall within the protection scope of the present invention.

1. A bacteria-controlling and stain-removing system for handrails in public places comprises clamping blocks with two left and right symmetry, wherein:
a moving mechanism is arranged in the clamping block and comprises two left and right symmetrical top wheels, and the handrails can be clamped up and down through the top wheels and the clamping blocks, the top wheel can move up and down along with the size of the handrail, and a rotatable transverse rotating wheel is arranged in the clamping block, the left and right sides of the handrail can be clamped by the transverse rotating wheel, so that the device can move along the handrail;
a driving mechanism is arranged on the upper side of the moving mechanism and comprises a top plate, and a motor is installed on the lower end face of the top plate, the transverse rotating wheel can be driven to rotate through the working of the motor, and the moving mechanism is in friction transmission with the driving mechanism through a belt;
a sterilization mechanism is arranged in the top plate, and comprises a storage block embedded in the top plate, and a storage cavity is formed in the storage block, the sterilization liquid is arranged in the storage cavity, and when the device moves along the handrail, the sterilization liquid in the storage cavity can be uniformly sprayed on the upper end surface of the handrail through the spray head.
an erasing mechanism is arranged on the rear side of the degerming mechanism and comprises a square cavity with a downward opening, a rotatable sponge block is arranged in the square cavity, and a movable cavity with an upward opening is formed in the right end wall of the square cavity, a rack is arranged in the moving cavity in a sliding mode, and the sponge block can be driven to rotate to the upper end surface of the handrail when the rack moves, so that the residual bacteria removing liquid on the upper end surface of the handrail can be wiped off.

2. The bacteria-controlling and stain-removing system for handrails in public places according to claim 1, wherein the moving mechanism comprises a containing cavity located in the clamping block, and the opening of the containing cavity faces the handrail, and a rotating shaft which penetrates through the upper end wall of the containing cavity and is positioned in the outside space is arranged on the lower end wall of the containing cavity in a rotating mode, the rotating shaft in the containing cavity is fixedly provided with the transverse rotating wheel, and the rotating shaft is fixedly provided with a belt wheel, away from the handrail, of the clamping block, and an elastic spring is fixedly arranged on the end wall, close to the handrail, of the elastic cavity, far away from the handrail, of the elastic spring is fixedly provided with a supporting rod in sliding connection with the elastic cavity, and the supporting rod is fixedly connected with the top plate, stress blocks are symmetrically and symmetrically fixed on the right side of the lower end surface of the clamping block, and an elastic cavity with a downward opening is arranged in the stress block, an elastic spring is fixedly arranged on the upper end wall of the elastic cavity, and an elastic rod which is in sliding connection with the elastic cavity is fixedly arranged at the lower end of the elastic spring, elastic shafts are arranged between the two elastic rods in a rotating mode, and the top wheels are fixedly arranged on the elastic shafts.

3. The bacteria-controlling and stain-removing system for handrails in public places according to claim 1, wherein the driving mechanism further comprises a transmission shaft rotationally connected with the lower end surface of the top plate, a transmission gear and a transmission rod are fixedly arranged on the transmission shaft, and the transmission rod is positioned on the lower side of the transmission gear, a motor shaft is rotationally arranged on the lower end surface of the motor, and a driving gear which is in meshed transmission with the transmission gear is fixedly arranged at the lower end of the motor shaft, the transmission shaft is connected with two first conical blocks and two second conical blocks in a sliding mode, an extending cavity with a downward opening is formed in the first conical block, and an extending spring is fixedly arranged on the upper end wall of the extending cavity, and an extending block which is in sliding connection with the extending cavity is fixedly arranged at the lower end of the extending spring, and an extension rod fixedly connected with the upper end surface of the second conical block is fixedly arranged on the lower end surface of the extension block, the belt is arranged between the second conical block and the first conical block, and the belt is in friction transmission with the belt wheel.

4. The bacteria-controlling and stain-removing system for handrails in public places according to claim 3, wherein a guide block is fixedly arranged on the rack in the movable cavity, and the guide block is in sliding connection with the movable cavity, a sensor is embedded in the right end wall of the moving cavity, and the sensor is connected with the motor through a data line.

5. The bacteria-controlling and stain-removing system for handrails in public places according to claim 1, wherein the sterilization mechanism further comprises a one-way cavity located in the top plate, and the upper end wall of the one-way cavity is communicated with the storage cavity through a guide pipe, a first one-way valve is arranged in the guide pipe, and a spraying guide pipe is arranged on the lower end wall of the first one-way valve, the lower end of the spraying guide pipe is positioned on the upper side of the handrail and is fixedly provided with the spray head, and a second one-way valve is arranged in the spraying guide pipe, a rotating cavity with a downward opening is formed in the right end wall of the one-way cavity, and a piston is arranged in the one-way cavity in a sliding mode, a piston rod which is positioned in the rotating cavity is fixedly arranged on the right end surface of the piston, and a threaded shaft which is rotationally connected with the right end wall of the rotating cavity is in threaded connection with the inner thread of the piston rod, and a first torsion spring is arranged between the threaded shaft and the right end wall of the rotating cavity, a vertical rod positioned in the external space is fixedly arranged on the lower end surface of the threaded shaft, and a short shaft is rotationally arranged in the left end surface of the vertical rod, a second torsion spring is arranged between the short shaft and the vertical rod, and a stressed rod is fixedly arranged at the left end of the short shaft.

6. The bacteria-controlling and stain-removing system for handrails in public places according to claim 1, wherein the wiping mechanism further comprises an output shaft rotationally connected with the upper end wall of the square cavity, and an output gear is fixedly arranged on the output shaft, the output gear is in meshed transmission with the rack, and a large bevel gear is fixedly arranged at the lower end of the output shaft, a power shaft is rotationally arranged on the right end wall of the square cavity, a small bevel gear and a rotating rod are fixedly arranged on the power shaft, and the rotating rod is located on the left side, the small bevel gear is in meshed transmission with the large bevel gear, and the sponge block is fixedly arranged at the rear end of the rotating rod.

7. The bacteria-controlling and stain-removing system for handrails in public places according to claim 1, wherein the sensor is used for detecting the rack and controlling the working state of the motor according to the state of the rack.
